(19) United States
(12) Patent Application Publication
(10) Pub. No.: US 2002/0011552 A1
(43) Pub. Date: Jan. 31, 2002

(54) Photodetector and distance measuring equipment using the same

(76) Inventors: Toshinobu Sugiyama, Kanagawa (JP); Kazuya Yonemoto, Kanagawa (JP); Shinichi Yoshimura, Tokyo (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/843,402

(22) Filed: Apr. 26, 2001

(30) Foreign Application Priority Data
Apr. 26, 2000 (JP) P2000-125955

(51) Int. Cl. H01L 27/00

(52) U.S. Cl. 250/208.1

(57) ABSTRACT

In distance measuring equipment for measuring the shape of a three-dimensional object by using a light sectioning method, charges accumulated in two photodiodes PDA, PDB provided every unit pixel of a pixel portion are successively read out as signal current to vertical signal lines. In a signal processing portion provided every column, it is judged in a comparator which photodiode PDA or PDB outputs higher light intensity. Therefore, the high/low intensity relationship is reversed when a laser beam passes over a specific pixel through a scanning operation of the laser beam, and the comparison output of the comparator circuit is reversed, so that the passage of the laser light over the unit pixel can be detected.

### RELATED APPLICATION DATA

The present application claims priority to Japanese Application No. P2000-125955 filed Apr. 26, 2000, which application is incorporated herein by reference to the extent permitted by law.

### BACKGROUND OF THE INVENTION

The present invention relates to a photodetector and distance measuring equipment using the same, and particularly to a photodetector serving as a semiconductor sensor array having pixels (cells) arranged in an array form and distance measuring equipment for measuring the shape of a three-dimensional object (the position measurement of the surface of the object) by using the photodetector.

Following increase of information processing speed and developments of networking, it has been recently increasingly promoted that the shape information of three-dimensional objects, that is, three-dimensional distance information is picked up and then three-dimensional picture contents thus obtained are used for applications such as games, electronic commerce, etc. Various methods have hitherto proposed and implemented to pick up such three-dimensional distance information.

Of these methods, a so-called light sectioning method of picking up three-dimensional distance information by using laser slit light and a special-purpose semiconductor sensor array is known as a method of enabling data to be achieved at high speed with high precision. Distance measuring equipment for performing the shape measurement of three-dimensional objects by using this light sectioning method is disclosed in Japanese Laid-open Patent Application No. Hei-5-322536, for example.

The concept of the distance measurement based on the light sectioning method will be described with reference to FIG. 11.

In this distance measurement, an object under measurement is exposed to laser slit light with being timely scanned by a scanning mirror, and reflection slight light from the object is detected by a special-purpose semiconductor sensor array. Two pieces of information on the pixel (cell) position in the semiconductor sensor array and the scanning timing (the irradiation angle of the reflection slit light) are achieved, and the distance information on the position of the object to which the slit light is irradiated is obtained on the basis of the above information by using a triangulation method.

Here, it is required for the semiconductor sensor array for detecting light to detect the reflection light of laser beams stably. The distance measurement equipment disclosed in the above publication uses such a semiconductor sensor array as shown in FIG. 12. As shown in FIG. 12, in a cell 101 of the sensor array, two photosensors 102A, 102B are arranged along the moving direction of the reflection slit light so as to be adjacent to each other, a comparator 104 for comparing photocurrent output from the sensors 102A, 102B through amplifiers 103A, 103B is provided, and the passage of the reflection slit light on the cell 101 is detected on the basis of the output of the comparator 104 which is led out through a gate 105.

In the semiconductor sensor array thus constructed, under a stationary state that no reflection slit light is irradiated, the two photosensors 102A, 102B are weighted so that the sensor sensitivity of any one of the photosensors 102A, 102B is increased and thus a judgment on light intensity is determined by one photosensor. When the reflection slit light is incident and the laser beam is irradiated to only the sensor having the lower sensitivity under the above state, the judgment result of the light intensity (sensitivity) is inverted and thus the passage of the reflection slit light can be detected.

As described above, the conventional distance measuring equipment uses the method of comparing the photocurrent output from the photosensors to carry out photodetection. That is, it is designed so that the photocurrent output from the two photosensors is merely compared with each other, and thus if some characteristic difference occurs between the sensor portions or amplifier portions, the comparison cannot be carried out with high precision. Further, photocurrent stationarily flows into each sensor portion, so that the current consumption in the overall chip is increased. In addition, various circuits such as an amplifier, a comparator, etc. are required to be provided every pixel, so that the ratio of the occupational area (numerical aperture) of the sensor portion to the pixel size is reduced and thus the sensitivity cannot be enhanced.

### SUMMARY OF THE INVENTION

The present invention has been implemented in view of the foregoing problem, and has an object to provide a photodetector which can detect incident light with high precision and distance measuring equipment using the photodetector.

In order to attain the above object, according to the present invention, there is provided a photodetector including: a pixel portion having unit pixels arranged in a matrix form, each unit pixel having two photoelectric conversion element; a first scanning portion for selecting the respective unit pixels of the pixel portion on a line basis; and a signal processing portion for processing signals output from the respective unit pixels every column for signal lines of the pixel portion arranged every column. The photodetector is used as a semiconductor sensor array for detecting slit light reflected from a three-dimensional object in distance measuring equipment for measuring the shape of a three-dimensional object by using a light sectioning method.

In the photodetector and the distance measuring equipment using the photodetector, when slit light scans along the surface of an object under measurement, the reflection slit light reflected from the surface of the object is incident to the photodetecting face of a pixel portion (semiconductor sensor array). The respective pixels of the pixel portion are selected on a line basis through the scanning operation of the first scanning portion. The time point at which the reflection slit light passes over each pixel on the photodetecting face is detected on the basis of the two signals output from the two photoelectric conversion elements of the pixel concerned by a signal processing portion equipped every column, and the position of the surface of the object under measurement is determined on the basis of the above detection result by a processing unit.

### BRIEF DESCRIPTION OF THE DRAWINGS

FIG. 1 is a diagram showing a photodetector according to a first embodiment of the present invention;

FIG. 2 is a circuit diagram showing the construction of each part of the photodetector according to the first embodiment;

FIG. 3 is a circuit diagram showing specific circuits subsequent to an I-V converting circuit;

FIG. 4 is a timing chart showing the circuit operation of the photodetector according to the first embodiment;

FIG. 5 is a diagram showing an embodiment of distance measuring equipment according to the present invention;

FIG. 6 is a diagram showing a photodetector according to a second embodiment of the present invention;

FIG. 7 is a timing chart showing the circuit operation of the photodetector according to the second embodiment of the present invention;

FIG. 8 is a diagram showing the construction of a photodetector according to a modification of the second embodiment of the present invention;

FIG. 9 is a timing chart showing the circuit operation of a photodetector according to a modification of the second embodiment;

FIG. 10 is a diagram showing the construction of a photodetector according to a third embodiment of the present invention;

FIG. 11 is a diagram showing the concept of distance measurement based on a light sectioning method; and

FIG. 12 is a block diagram showing the construction of a unit cell of a semiconductor sensor array according to a prior art.

### DETAILED DESCRIPTION OF THE PREFERRED EMBODIMENTS

Preferred embodiments according to the present invention will be described hereunder with reference to the accompanying drawings.

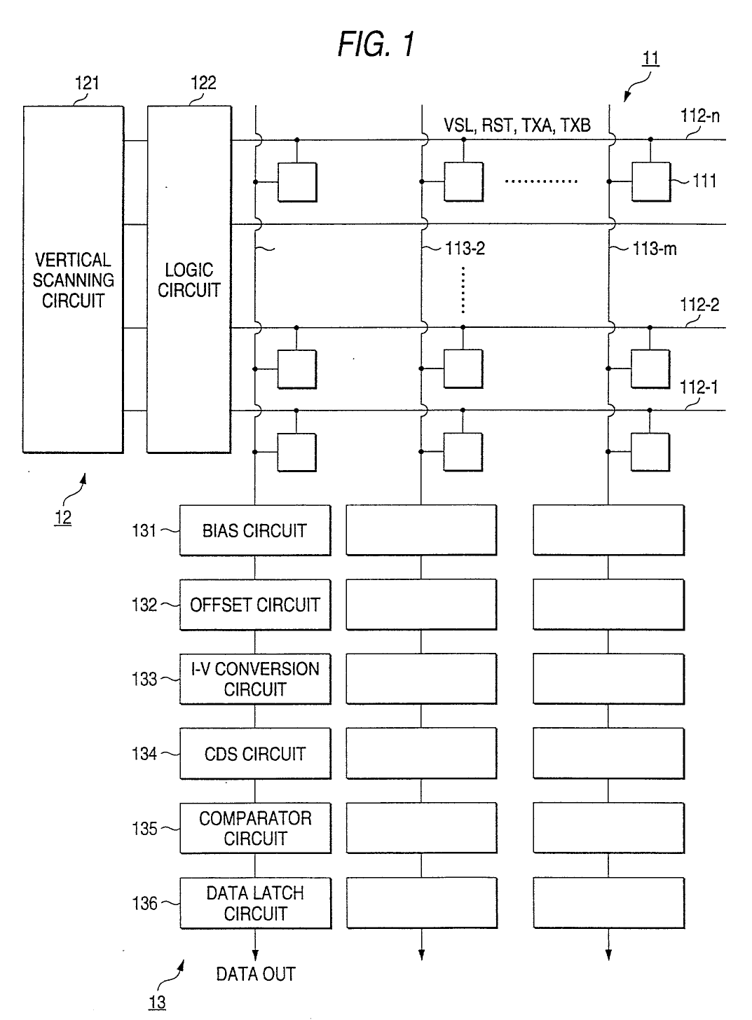

FIG. 1 is a diagram showing the construction of a photodetector according to a first embodiment of the present invention. The photodetector according to the first embodiment includes a pixel portion 11, a vertical scanning portion 12 and a signal processing portion 13.

The pixel portion 11 has many unit pixels 111 arranged in a matrix form on a semiconductor substrate (hereinafter referred to as “chip”), line selection lines 112-1 to 112-n whose number corresponds to the number of pixels (n) in the vertical direction (the number of pixels arranged on each line) and vertical signal lines 113-1 to 113-m whose number corresponds to the number of pixels (m) in the horizontal direction (the number of pixels arranged on each column). The line selection lines 112-1 to 112-n and the vertical signal lines 113-1 to 113-m are arranged in a matrix form in conformity with the matrix arrangement of the unit pixels 111.

The vertical scanning portion 12 includes a vertical scanning circuit 121 comprising shift registers, and a logic circuit 122. Since the respective pixels 111 of the pixel portion 11 are successively selected on a line basis with being successively scanned in the vertical direction by the vertical scanning circuit 121, the vertical scanning portion 12 is designed to output various kinds of control signals VSL, RST, TXA and TXB on a line basis through the logic circuit 122.

The signal processing portion 13 includes a bias circuit 131, an offset circuit 132, an I(current)-V(voltage) conversion circuit 133, CDS (Correlated Double Sampling) circuit 134, a comparator circuit 135 and a data latch circuit 136 which are arranged in this order. Each signal processing portion 13 is connected to each of the output terminals of the vertical signal lines 113-1 to 113-n every column, and processes the signal of each of the vertical signal lines 113-1 to 113-n every column.

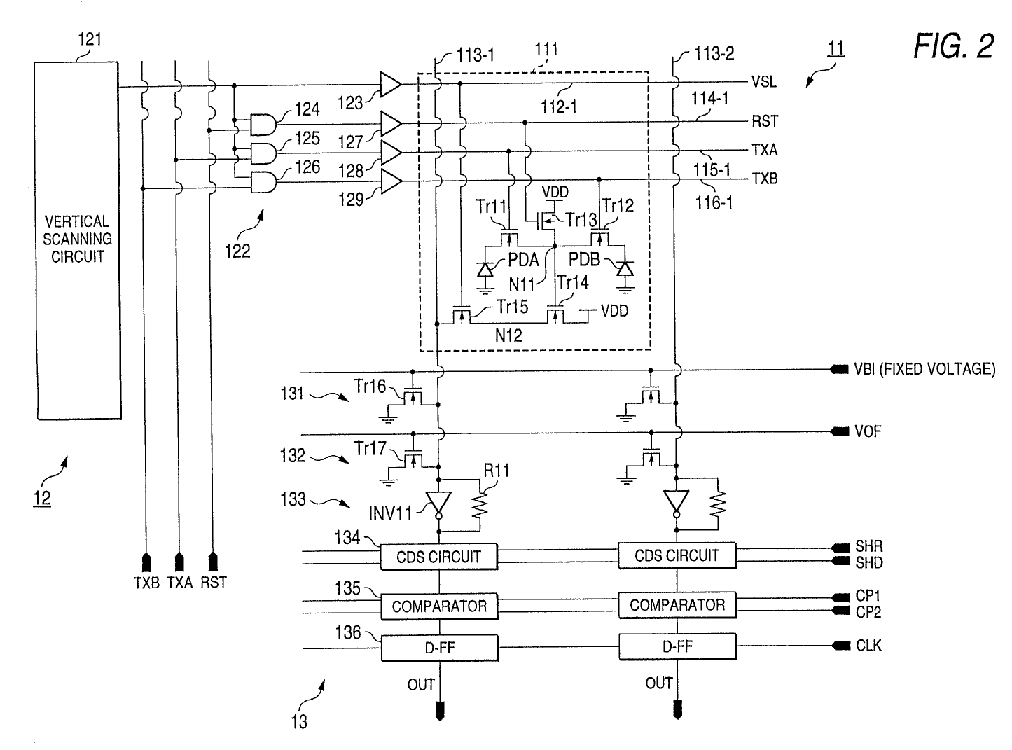

FIG. 2 shows the specific construction of each portion of the photodetector according to the first embodiment of the present invention. In order to simplify the drawings, the specific circuit construction of only a unit pixel 111 on the first line and the first column and the peripheral circuits is shown in FIG. 2.

In FIG. 2, the unit pixel 111 has two photoelectric conversion elements such as photodiodes PDA, PDB. Each anode of the photodiodes PDA, PDB is grounded. MOS transistors Tr11, Tr12 for read-out of signals are connected between each cathode of the photodiodes PDA, PDB and a floating diffusion (hereinafter referred to as “node N11”) serving as an accumulation portion for accumulating signal charges.

Further, a reset MOS transistor Tr13 for resetting the potential of the node N11 is connected between the node N11 and a power source VDD, and an amplifying MOS transistor Tr14 and a line-selecting MOS transistor Tr15 are connected in series between the power source VDD and the vertical signal line 113-1. The gate of the amplifying MOS transistor Tr 14 is connected to the node N11.

Further, in addition to the line selecting line 112-1, a reset control line 114-1 and two read-out control lines 115-1, 116-1 are arranged in the column direction in the unit pixel 111 on the first line. The gates of the read-out MOS transistors Tr11, Tr12 are connected to the read-out control lines 115-1, 116-1, the gate of the reset MOS transistor Tr 13 is connected to the reset control line 114-1, and the gate of the line selecting MOS transistor Tr 15 is connected to the line selecting line 112-1.

In the vertical scanning portion 12, the read-out control signals TXA, TXB for reading out the charges accumulated in each of the photodiodes PDA, PDB and the reset control signal RST for resetting the potential of the node N11 are input from a timing control circuit (not shown) to the logic circuit 122, and also a line selecting signal VSL is given from the vertical scanning circuit 121 to the logic circuit 122.

In the logic circuit 122, the line selecting signal VSL given from the vertical scanning circuit 121 is supplied through a buffer 123 to the line selecting line 112-1, and also input to respective one terminals of AND circuits 124, 125, 126 of the logic circuit 122. The reset control signal RST input passes through the AND circuit 124 and then is supplied through a buffer 127 to the reset control line 114-1. The read-out control signals TXA, TXB pass through the AND circuits 125, 126 respectively, and then are supplied through buffers 128, 129 to the read-out control lines 115-1, 116-1.

In the signal processing unit 13, the bias circuit 131 is constructed by an MOS transistor Tr16 for bias. The bias MOS transistor Tr16 is connected between the vertical signal line 131-1 and the ground, and a predetermined bias voltage (fixed voltage) VB1 is applied to the gate of the bias MOS transistor Tr 16. The bias circuit 131 is used to adjust the operating point of the I-V conversion circuit 133.

The offset circuit 132 is constructed by an MOS transistor Tr 17 for offset. The offset MOS transistor Tr 17 is connected between the vertical signal line 131-1 and the ground, and a predetermined offset voltage VOF is applied to the gate of the offset MOS transistor Tr 17. The offset circuit 132 is used to give an offset to any one of the signals from the photodiodes PDA, PDB of the unit pixel 111.

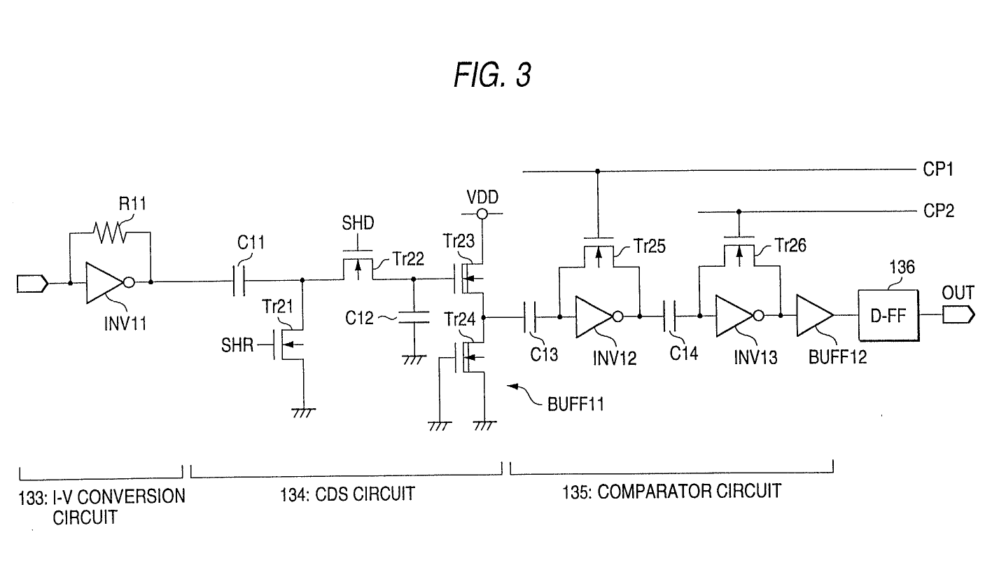

FIG. 3 shows the specific circuits subsequent to the I-V conversion circuit 133.

First, a circuit comprising an inverter INV11 and a feedback resistor R11 connected between the input/output terminals of the inverter may be used as the I-V conversion circuit 133. This type of I-V conversion circuit 133 is simple in circuit construction, and thus the lay-out area thereof on the chip may be small. Therefore, it can be easily disposed every column.

With respect to the CDS circuit 134, it is basically constructed by capacitors and switch transistors, and the buffer amplifier at the final stage thereof is constructed by two MOS transistors. Use of this circuit construction enables the circuit scale to be reduced, and thus it can be easily provided every column as in the case of the I-V conversion circuit 133.

Specifically, the CDS circuit 134 includes a clamping capacitor C11, a clamping MOS transistor Tr 21 whose one main electrode is connected to the output terminal of the clamping capacitor C11, a sample hold MOS transistor Tr 22 whose one main electrode is connected to the output terminal of the clamping capacitor C11, and a sample hold capacitor C12 which is connected between the other main electrode of the sample hold MOS transistor Tr 22 and the ground.

A sample hold reset signal SHR is applied to the gate of the clamping MOS transistor Tr 21, and a sample hold data signal SHD is applied to the gate of the sample hold MOS transistor Tr 22. A source follower circuit comprising two MOS transistors Tr 23, Tr 24 which are connected in series between the power source VDD and the ground is used as a buffer amplifier Buff11 at the last stage.

The CDS circuit 134 thus constructed acts as a noise removing circuit for clamping the feed through level (reference signal level) in synchronism with the sample hold reset signal SHR for the signal of each pixel 111 supplied through the I-V conversion circuit 133, sample-hold the signal level in synchronism with the sample hold data signal SHD and calculating the difference between the feed through level and the signal level thus sample-held to cancel the pixel-inherent noise components contained in the signal.

A chopper type comparator comprising an inverter and an MOS transistor connected between the input and output terminals of the inverter is used as the comparator circuit 135. In this case, two cascade-connected chopper type comparators are used to enhance the comparison precision.

Specifically, a comparator COMP1 at the first stage comprises a capacitor C13, an inverter INV12 and an MOS transistor Tr25 connected between the input and output terminals of the inverter INV12, and a comparate signal CP1 is applied to the gate of the MOS transistor Tr 25. Likewise, a comparator COMP2 at the second stage comprises a capacitor C14, an inverter INV13 and an MOS transistor Tr26 connected between the input and output terminals of the inverter INV13, and a comparate signal CP2 is applied to the gate of MOS transistor Tr26.

The output of the chopper type comparator COMP2 at the second stage is supplied through the buffer Buff12 to a data latch circuit 136. The data latch circuit 136 is constructed by a D-type flip flop (D-FF), for example.

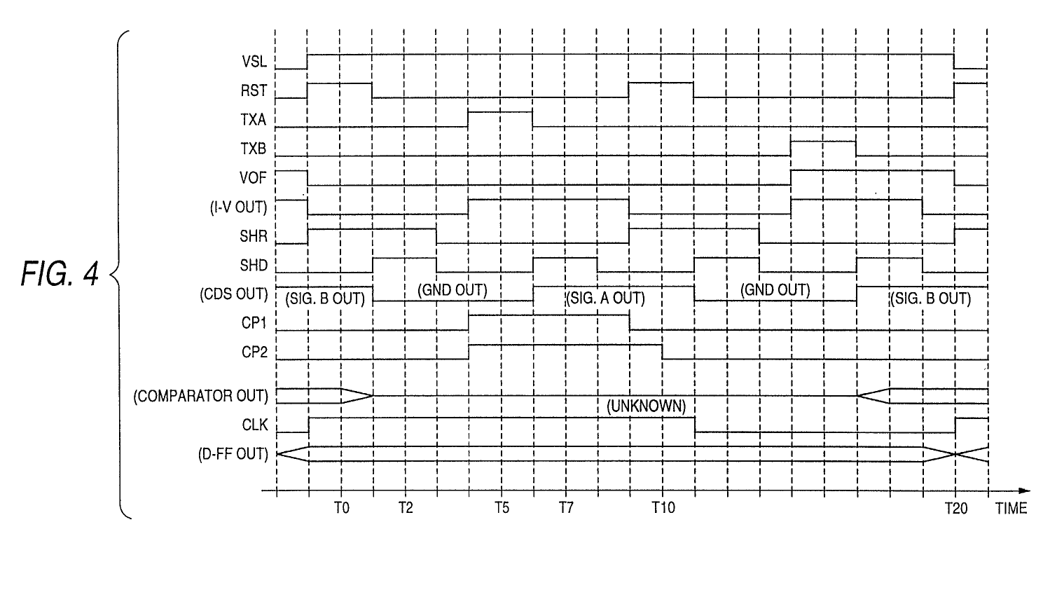

Next, the circuit operation of the photodetector according to the first embodiment will be described with reference to the timing chart of FIG. 4.

First, in the pixel portion 11, the photoelectric conversion is carried out in the two photodiodes PDA, PDB every unit pixel 111, whereby charges are accumulated in the photodiodes PDA, PDB. The charges of each pixel 111 are collectively read out line by line through the vertical scanning operation of the vertical scanning circuit 121.

Specifically, paying attention to the unit pixel 111 on the first line and first column shown in FIG. 2, the first line is first selected by the vertical scanning operation of the vertical scanning circuit 121. When the line selection signal VSL having a high level is applied to the line selection line 112-1 at time T0, the MOS transistor Trl5 for vertical selection is switched to ON state. Therefore, the connection point between the amplifying MOS transistor Trl4 and the vertical selecting MOS transistor Trl5 (hereinafter referred to as “node N12”) is kept to be conducted to the vertical signal line 113-1.

When the reset control signal RST having a high level is input at the same time T0, the reset MOS transistor Tr13 is set to ON-state, and the node N11 is charged to the power source voltage VDD (for example, 3.3V). Thereafter, the read-out control signal TXA having a high level is input at time T5 to switch the read-out MOS transistor Tr11 to ON-state, whereby the charges (electrons in this embodiment) accumulated in the photodiode PDA through the photoelectric conversion are read out to the node N11.

Through this read-out operation, the potential of the node N11 drops from 3.3V (under the reset state) to the value corresponding to the light intensity of incident light to the photodiode PDA. The current corresponding to the potential of the node N11 flows through the amplifying MOS transistor Trl4 and the line selecting MOS transistor Trl5 into the vertical signal line 113-1.

The current flowing into the vertical signal line 113-1 in accordance with the light intensity of the light incident to the photodiode PDA passes through the bias circuit 131 and the offset circuit 132, and is converted to the corresponding voltage signal level in the I-V conversion circuit 133. Thereafter, the pixel-inherent noise components are canceled from the voltage signal thus converted in the CDS circuit 134. The reset operation and the data sample hold operation in the CDS circuit 134 are carried out in synchronism with the sample hold reset signal SHR set to the high level at time T0 and the sample hold data signal SHD set to the high level at time T7.

Likewise, when the reset control signal RST having a high level is input at time T15, the node N11 is reset. Further, when the read-out control signal TXB having the high level is input at time T15, the charges accumulated in the photodiode PDB are read out to the node N11, and the current corresponding to the potential of the node N11 flows through the amplifying MOS transistor Trl4 and the line selecting MOS transistor Trl5 into the vertical signal line 113-1.

The current flowing into the vertical signal line 113-1 in accordance with the light intensity of the photodiode PDB passes through the bias circuit 131 and the offset circuit 132, and is converted to the voltage signal level in the I-V conversion circuit 133. Thereafter, the pixel-inherent noise components are cancelled in the CDS circuit 134. The signals Sig.A, Sig.B of the photodiodes PDA, PDB which have been subjected to the noise cancel processing are successively output from the CDS circuit 134, and input to the chopper type comparator circuit 135 at the rear stage.

The chopper type comparator circuit 135 is initialized by the comparate signals CP1, CP2 which are set to the high level at the time when the signal Sig. A for the photodiode PDA is input. When the signal Sig.B for the photodiode PDB is input, the comparison output between the two values of the comparator 135 is determined on the basis of the comparison in magnitude between the signal Sig. A and the signal Sig. B. The comparison output is latched in the data latch circuit 136 at the rear stage, and output to the external of the chip as the judgment data for each pixel.

As described above, in the photodetector according to the first embodiment, two photodiodes PDA, PDB are provided every unit pixel 111, and the charges achieved and accumulated through the photoelectric conversion are successively read out to the vertical signal lines 113-1 to 113-m as signal current. By the comparator circuit 135 provided every column, it is judged which photodiode PDA or PDB receives light having a higher light intensity. Accordingly, through the scanning operation of the incident light, when the incident light passes over a specific pixel, the high/low relationship in the light intensity is inverted, and thus the comparison output of the comparator circuit 135 is reversed, so that the passage of the incident light on the unit pixel 111 can be detected.

Particularly, the signal processing portion 13 is provided every column, and the processing of comparing the respective signals Sig. A and Sig.B of the two photodiodes PDA, PDB is carried out. Therefore, even when there is a difference in characteristic between the photodiodes PDA, PDB, the comparison can be performed with high precision, and thus the detection sensitivity can be enhanced.

The conventional photodetector detects photocurrent induced by light. On the other hand, the photodetector according to this embodiment detects the charges accumulated in the photodiodes PDA, PDB. Therefore, in this embodiment, photocurrent does not stationarily flow, and thus the current consumption in the overall chip can be reduced. Further, each unit pixel 111 is constructed in a simple structure having two photodiodes PDA, PDB and five MOS transistors. Therefore, the rate of the occupation area of the circuit portion to the pixel size, that is, the numerical aperture can be increased, and thus the sensitivity can be further enhanced.

The photodetector according to the first embodiment as described above can be used as a semiconductor sensor array for detecting slight light reflected from a three-dimensional object in distance measuring equipment for measuring the shape of the three-dimensional object by using a light sectioning method.

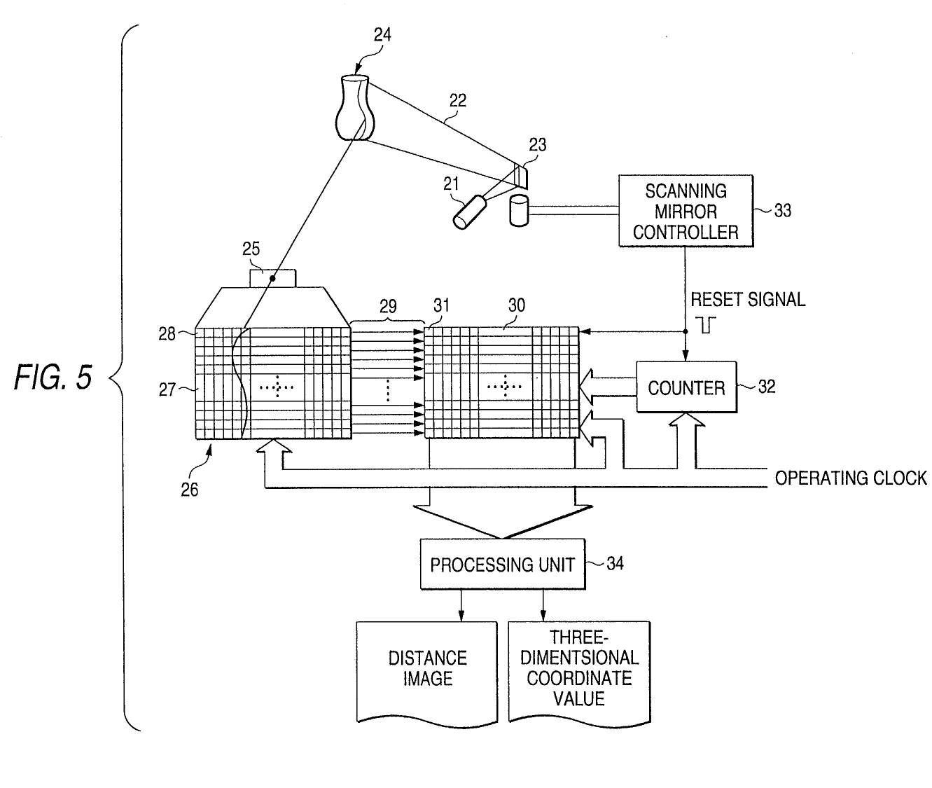

FIG. 5 is a diagram showing the construction of an embodiment of the distance measuring equipment according to the present invention.

In FIG. 5, slit light 22 emitted from a slit light generating laser 21 scans a three-dimensional object under measurement 24 by a scanning mirror 23 comprising a galvanic mirror or the like. For example, a semiconductor laser of 670 nm in wavelength (10 mW at the exit of the lens, about 1 mm in width of slit light) is used as the slit light generating laser 21.

The reflection slit light reflected from the object under measurement 24 is passed through a lens 25 and continuously irradiated to the photodetecting face 27 of the semiconductor sensor array 26. The photodetector according to the first embodiment as described above is used as the semiconductor sensor array 26. As a result, as apparent from the foregoing description, the semiconductor sensor array 26 has the pixel portion 11, the vertical scanning portion 12 and the signal processing portion 13 (see FIG. 1) although the detailed construction is omitted from the illustration of FIG. 5.

Here, the slit light which extends in the vertical direction and is irradiated to the object under measurement 24 is scanned in the horizontal direction. Each of many cells 28 (corresponding to the unit pixel 111 in FIG. 1) arranged in a matrix form contains two photodiodes PDA, PDB, and the photodetector is arranged so that the photodiodes PDA, PDB are arranged so as to be adjacent to each other in the moving direction of the slit light, that is, in the horizontal direction.

When the slit light passes over the object under measurement 24 in the direction corresponding to the line of sight, that is, the reflection slit light from the object under measurement 24 passes over each cell 28, the cell 28 outputs the signals Sig.A and Sig.B for the photodiodes PDA, PDB. These signals Sig.A, Sig.B are subjected to the signal processing such as comparison processing, etc. in the signal processing portion 13 (see FIGS. 1 and 2) provided every column, and output as judgment data every pixel.

The judgment data are read out by the reading portion 29, and the counter number output from the counter 32 at that time is stored in the memory cell 3 of the counter value storage memory 30 corresponding to the cell 28 outputting the judgment data. The count operation of the counter 32, the driving of the semiconductor sensor array 26 and the control of the counter value storage memory 30 are carried out in synchronism with operating clocks (for example, about 100 KHz) input from the external.

The scanning mirror 23 is controlled to rotate at a constant angular speed by a scanning mirror control device 33. The scanning mirror control device 33 outputs a reset signal (for example, about 60 Hz) every time the scanning mirror 23 makes one revolution. The reset signal is supplied to the counter number storage memory 30 and the counter 32 to reset the contents of these parts. Accordingly, the count number of the counter 32 corresponds to the angle information of the scanning mirror 23.

The count number stored in each memory cell 31 of the count number storage memory 30 is given to a processing unit 34. The processing unit 34 converts the count number stored in each memory cell 31 to the corresponding distance information. The processing unit 34 superposes the distance information thus converted on video information and output it as a distance image, or outputs it as a three-dimensional coordinate value of the object under measurement 24 which is being observed by each cell 28 of the semiconductor sensor array 26.

As described above, by using the photodetector according to the first embodiment of the present invention as the semiconductor sensor array 26 in the distance measuring equipment for performing the shape measurement of a three-dimensional object by using the light sectioning method, the detection sensitivity of the laser reflection slit light reflected from the object under measurement 24 can be enhanced because the detection sensitivity of the photodetector is high, resulting in enhancement of the precision of the three-dimensional distance measurement. As a result, the external environment (daily light) and the measurable range to the subject (texture, etc.) are broadened, and thus the high-speed measurement can be performed, so that the shape of a mobile such as a moving object or the like can be measured on a real-time basis.

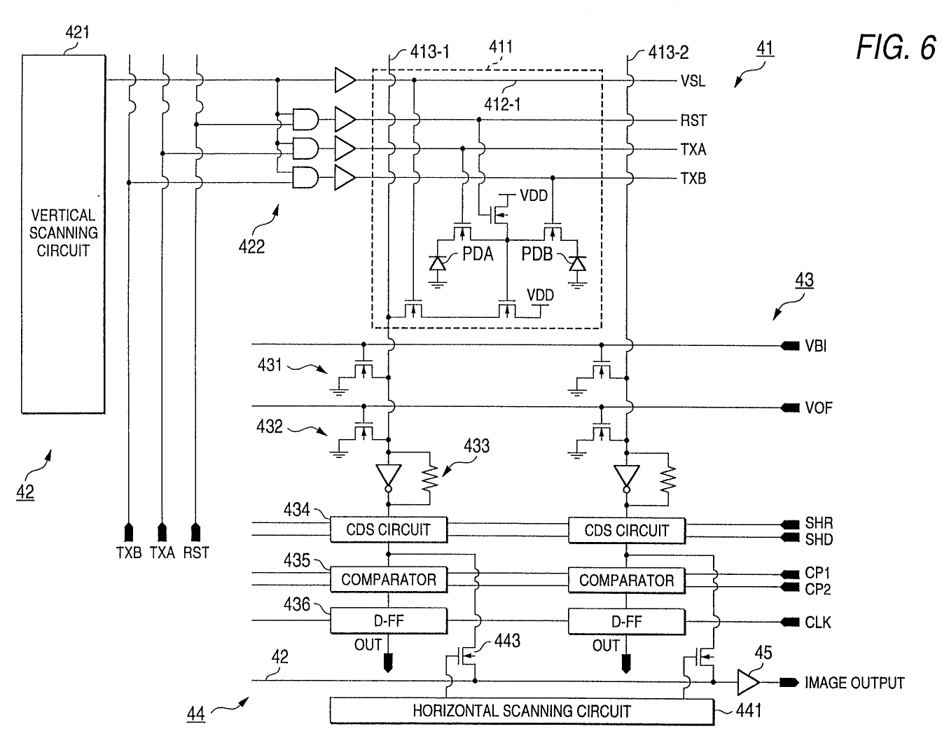

FIG. 6 is a diagram showing the construction of a photodetector according to a second embodiment of the present invention.

The photodetector according to the second embodiment includes a pixel portion 41, a vertical scanning portion 42, a signal processing portion 43 and a horizontal scanning portion 44, and it is characterized in that the horizontal scanning portion 44 is newly added to the photodetector of the first embodiment.

The pixel portion 41 includes many unit pixels 411 arranged in a matrix form, line-selecting lines 412-1 to 412-n whose number corresponds to the number of pixels (n) in the line direction and vertical signal lines 413-1 to 413-m whose number corresponds to the number of pixels (m) in the column direction, the line-selecting lines and the vertical signal lines being arranged in a matrix form in connection with the matrix arrangement of the unit pixels 411. In this case, in order to simplify the drawings, only the unit pixel 411 on the first line and first column is shown. The unit pixel 411 is designed to have two photodiodes PDA, PDB and five MOS transistors as in the case of the first embodiment.

The vertical scanning portion 42 has a vertical scanning circuit 421 comprising a shift register or the like, and a logic circuit 422, and it is designed to output various kinds of control signals VSL, RST, TXA, TXB on a line basis through the logic circuit 422 in order to select the respective pixels 411 of the pixel portion 41 on a line basis while the vertical scanning circuit 421 successively scans the pixels in the vertical direction. The logic circuit 422 comprises three AND circuits and four buffers as in the case of the first embodiment.

In the signal processing portion 43, a bias circuit 431, an offset circuit 432, an I-V conversion circuit 433, a CDS circuit 434, a comparator circuit 435 and a data latch circuit 436 are connected in this order to each output terminal of the vertical signal lines 413-1 to 413-m every column, and the signals from the vertical signal lines 413-1 to 413-n are processed every column.

In the signal processing portion 43 thus constructed, the bias circuit 431 is used to adjust the operating point of the I-V conversion circuit 433. It is connected between the vertical signal line 431-1 and the ground, and constructed by a biasing MOS transistor having a gate to which a predetermined bias voltage VBI is applied.

The offset circuit 432 is provided to give an offset to any one of the signals from the photodiodes PDA, PDB in the unit pixel 411, and connected between the vertical signal line 431-1 and the ground. It is constructed by an MOS transistor for offset and a predetermined offset voltage VOF is applied to the gate thereof.

The same circuit construction as shown in FIG. 3 is used for the I-V conversion circuit 433, the CDS circuit 434, the comparator circuit 435 and the data latch circuit 436. That is, the I-V conversion circuit 433 comprises an inverter and a feedback resistor, and the CDS circuit 435 basically comprises capacitors and switch transistors. Further, a chopper type comparator is used as the comparator circuit 435, and D-FF is used as the data latch circuit 436.

The horizontal scanning portion 44 includes a horizontal scanning circuit 441 comprising, for example, a shift register, and a column selecting transistor 443 which is connected between each output terminal of the CDS circuit 434 and the horizontal signal line 442. Here, since the CDS circuit 434 is provided for each of the vertical signal lines 413-1 to 413-m of m and thus the column selecting transistors 443 whose number is equal to the number of pixels m in the column direction are arranged in connection with the CDS circuits 434.

In the horizontal scanning portion 44, the horizontal scanning circuit 441 successively outputs a column selection signal HSL while scanning successively in the horizontal direction (column direction). The column selection signal HSL which is successively output from the horizontal scanning circuit 441 is successively applied to the gate of the corresponding column selection transistor 443. At this time, the column selection transistor 443 is switched to ON-state to output the signal of each pixel 411 passing through the CDS circuit 434 to the horizontal signal line 442. This signal is passed through a buffer 45 as an image output.

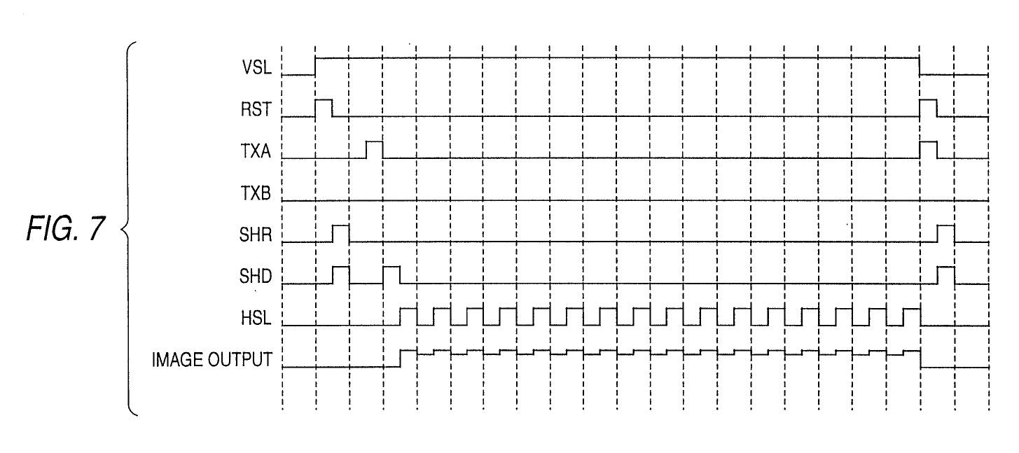

Next, the circuit operation of the photodetector according to the second embodiment will be described with reference to the timing chart of FIG. 7. In the timing chart of FIG. 7 is shown the timing relationship of one line period (of one line) when the signal Sig.A based on the photodiode PDA is read out.

The circuit operation in which the signal of each pixel 411 is output as pixel-based judgment data to the outside of the chip through the signal processing portion 43 provided every column, that is, the bias circuit 431, the offset circuit 432, the I-V conversion circuit 433, the CDS circuit 434, the comparator circuit 435 and the data latch circuit 436 is the same as the first embodiment, and thus the description thereof is omitted from the following description.

In the photodetector according to this embodiment, the signal of the pixel 411 is branched at the output stage of the CDS circuit 434, and output to the horizontal signal line 442 through the column selection transistor 443. The column selection transistor 443 is successively turned on in response to the column selection signal HSL that is successively output from the horizontal scanning circuit 441, whereby the respective signals of the pixels 441 of one line which are selected on a line basis through the vertical scanning operation are successively output to the horizontal signal line 442.

The signals output to the horizontal signal line 442 are output as an image output to the outside of the chip through the buffer 45. The image output may be supplied to a monitor or the like to display a real image on the monitor.

Here, The two signals of the signal Sig.A based on the photodiode PDA and the signal Sig.B based on the photodiode PDB are output as the signal of one pixel 411. As the manner of reading out these two signals Sig. A and Sig.B are available various manners such as a manner of reading out only the signal Sig.A, a manner of reading out only the signal Sig.B, a manner of reading out the signal Sig.A within one line and then reading out the signal Sig.B, a manner of alternately reading out the signals Sig.A and Sig.B every frame, etc.

The photodetector according to the second embodiment described above is also used s a semiconductor sensor array for detecting slit light reflected from a three-dimensional object in the distance measuring equipment for performing the shape measurement of the three-dimensional object by using the light sectioning method as in the case of the first embodiment.

In the conventional distance measuring equipment, an imaging sensor for texture mapping is used in addition to a semiconductor sensor array for distance measurement. On the other hand, by using the photodetector according to the second embodiment as the semiconductor array sensor array of the distance measuring equipment, both the functions of the semiconductor sensor array for distance measurement and the image sensor for texture mapping can be performed by only one sensor (photodetector) because the photodetector can output pick-up image data.

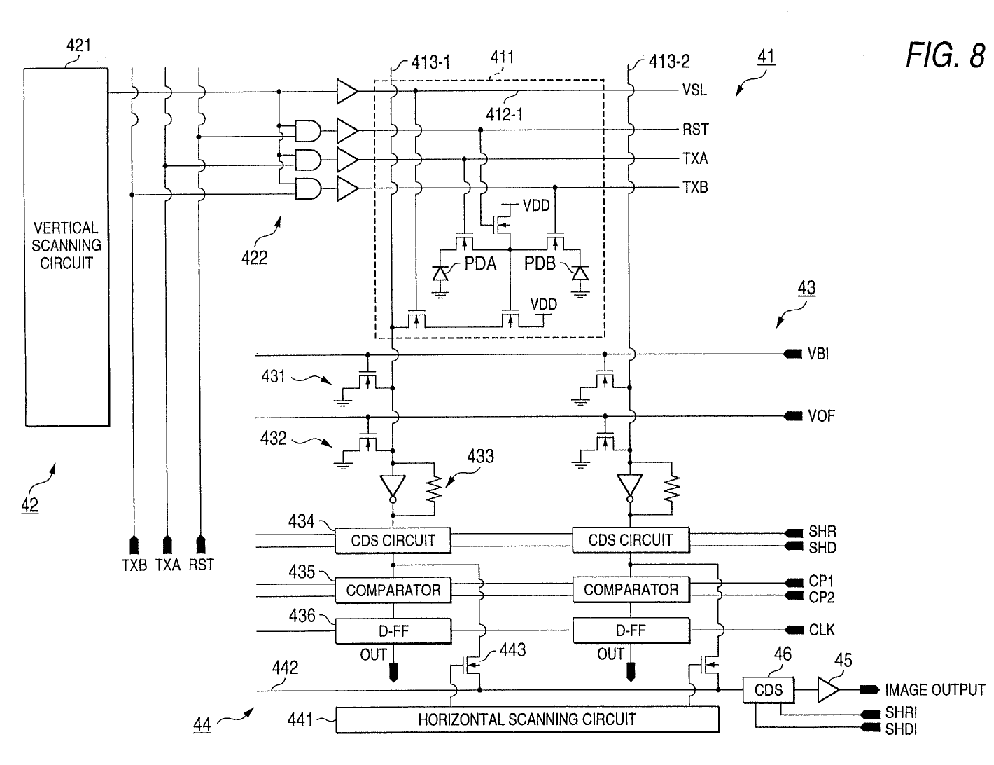

In the photodetector according to the second embodiment, the signals of the pixel 411 are branched at the output stage of the CDS circuit 434, and the then output through the column selecting transistor 443 to the horizontal signal line 442. However, as shown in FIG. 8, the signal of the pixel 411 may be branched at the output stage of the I-V conversion circuit 443 and then output through the column selecting transistor 443 to the horizontal signal line 442.

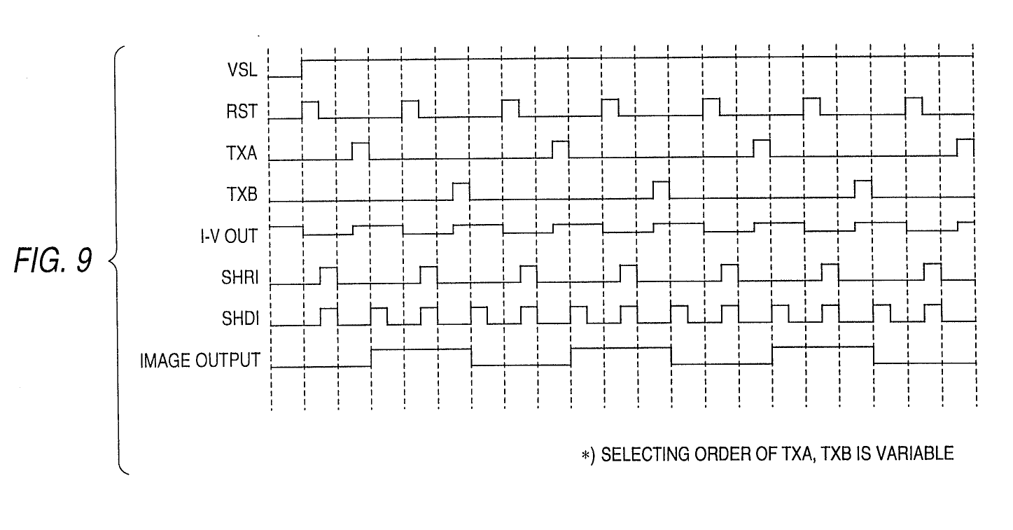

In FIG. 8, the same parts as shown in FIG. 6 are represented by the same reference numerals. In this case, the CDS circuit 46 is provided at the output side of the horizontal signal line 442, and noises are canceled for the image output obtained through the image pickup operation every signal of each pixel 411. However, in this case, it is necessary to output the reset signal and the image signal every pixel 411, and thus the reset and transmission are repeated every pixel as shown in the timing chart of FIG. 9.

As in the case of the photodetector according to the second embodiment, the photodetector according to the modification of the second embodiment is also used as the semiconductor sensor array having both the functions of the distance measuring sensor and the texture mapping image sensor in the distance measuring equipment for measuring the shape of a three-dimensional object by using the light sectioning method.

As described above, when the distance measurement and the image pickup operation are performed by using the same semiconductor sensor array, the accumulation time of charges (the light irradiation time at a read-out time interval) in the photodiodes PDA, PDB is varied between the distance measuring operation and the image pickup operation. Normally, the accumulation time in the distance measuring operation is shorter than that in the image pickup operation, and thus the photodetector is designed so that the sensor sensitivity of the photodiodes PDA, PDB is sufficient in the distance measuring operation.

However, when the photodetector is designed so that the sensor sensitivity of the photodiodes PDA, PDB in the distance measurement is set as the standard sensitivity, the sensor sensitivity becomes excessively high in the image pickup operation with a long accumulation time, and thus the optimum image signal may not be obtained. In order to solve this problem, the following photodetector according to a third embodiment of the present invention has been implemented.

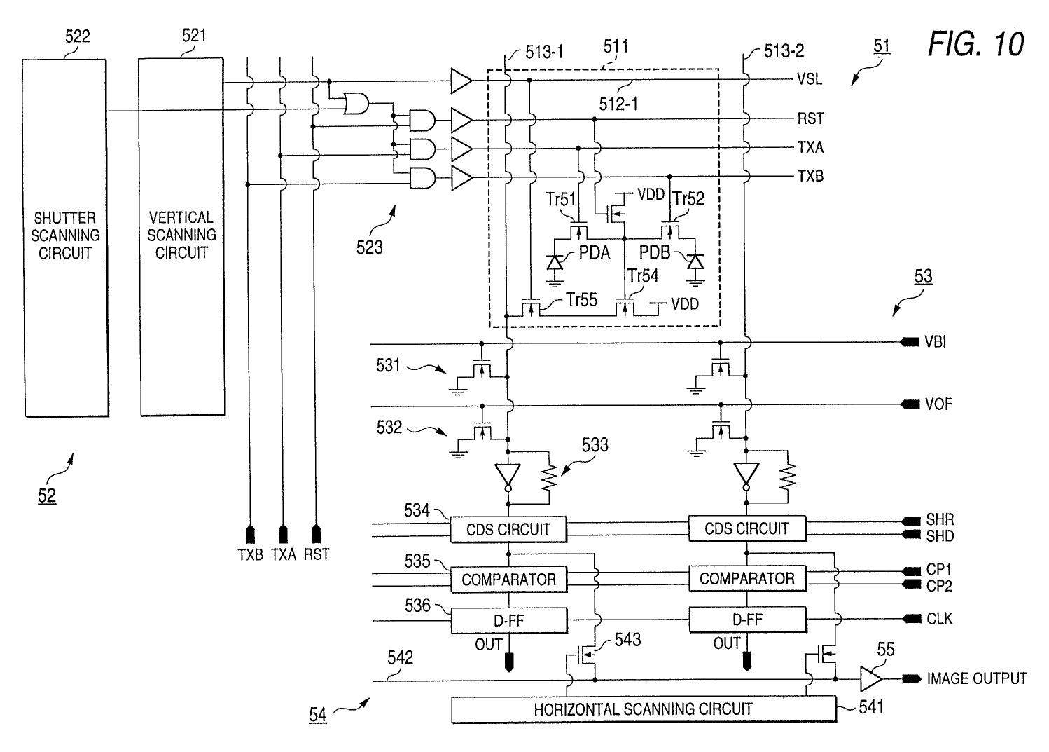

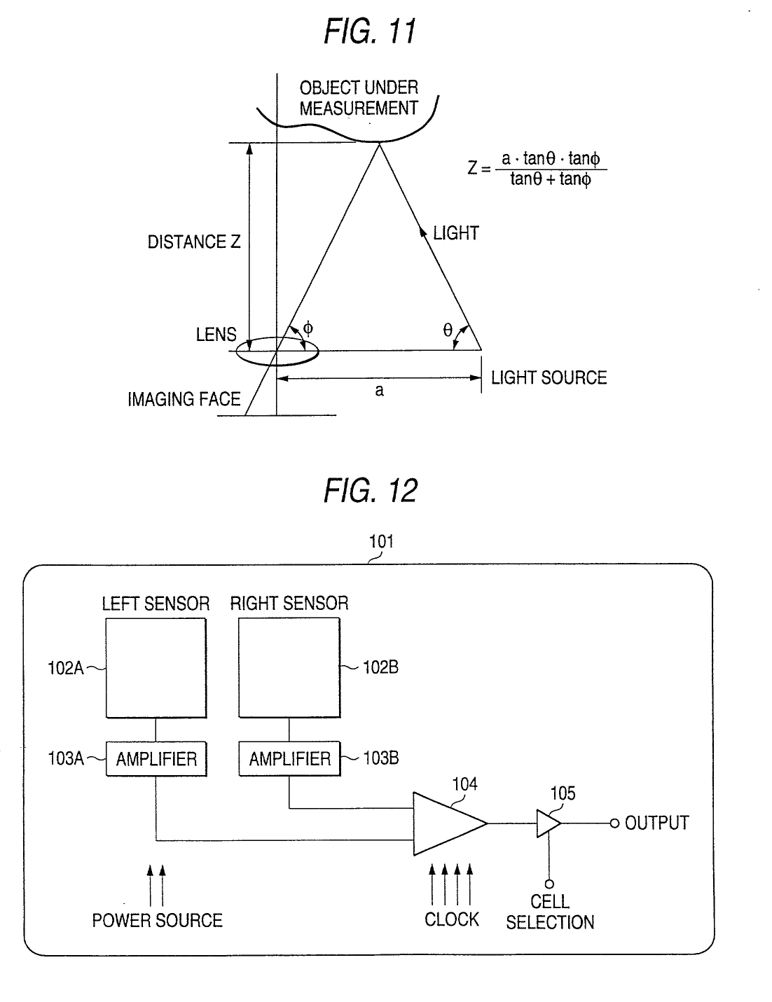

FIG. 10 is a diagram showing the construction of the photodetector according to the third embodiment of the present invention. The photodetector according to this embodiment includes a pixel portion 51, a vertical scanning portion 52, a signal processing portion 53 and a horizontal scanning portion 54, and it is characterized by the construction of the vertical scanning portion 52.

The pixel portion 51 includes many unit pixels 511 arranged in a matrix form, line-selecting lines 512-1 to 512-n whose number corresponds to the number of pixels (n) in the line direction and vertical signal lines 513-1 to 513-m whose number corresponds to the number of pixels (m) in the column direction, the line-selecting lines and the vertical signal lines being arranged in a matrix form in connection with the matrix arrangement of the unit pixels 511. In this case, in order to simplify the drawings, only the unit pixel 511 on the first line and first column is shown. The unit pixel 511 is designed to have two photodiodes PDA, PDB and five MOS transistors Tr51 to Tr55 as in the case of the first and second embodiments.

The vertical scanning portion 52 has a vertical scanning circuit 521, a shutter scanning circuit 522 and a logic circuit 523, and it is designed to output various kinds of control signals VSL, RST, TXA, TXB on a line basis through the logic circuit 523 in order to select the respective pixels 511 of the pixel portion 51 on a line basis while scanning circuits 521,522 successively scans the pixels in the vertical direction.

The vertical scanning circuit 521 comprises a shift register, for example, and successively outputs a line selection signal VSL to select the unit pixels 511 on a line basis while scanning the unit pixels in the vertical direction. The shutter scanning circuit 522 is provided to control the accumulation time at the unit pixels 511 on a line basis, and it comprises a shift register as in the case of the vertical scanning circuit 521. The logic circuit 523 comprises three AND circuits and four buffers as in the case of the first and second embodiments.

In the vertical scanning portion 52, the shutter scanning circuit 522 outputs a shutter signal to a line at a time that is earlier by a predetermined time than the timing at which the line selection signal VSL is output from the vertical scanning circuit 521 to the same line. In each pixel 511 of the line to which the shutter signal is supplied, the charges that have been accumulated in the photodiodes PDA, PDB until that time are read out as undesired charges by the reading MOS transistors Tr51, Tr52 while the line selecting MOS transistor Tr55 is kept to be in non-selected state.

The time period (the above predetermined time) from that time point until the line selection signal VSL is supplied is set as the accumulation time, and the charges accumulated for the phtodiodes PDA, PDB of each pixel 511 are read out as the signal of the pixel 511 in response to the supply of the line selecting signal VSL. That is, the time interval between the output timing of the shutter signal and the output timing of the line selecting signal for the same line is equal to the accumulation time, and the accumulation time can be controlled within the period corresponding to one frame by the output timing of the shutter signal.

In the signal processing portion 53, a bias circuit 531, an offset circuit 532, an I-V conversion circuit 533, a CDS circuit 534, a comparator circuit 535 and a data latch circuit 536 are connected in this order to each of the output terminals of the vertical signal lines 513-1 to 513-m every column, the signals from the vertical signal lines 513-1 to 513-m are processed every column.

In the signal processing portion 53 thus constructed, the bias circuit 531 is provided to adjust the operating point of the I-V conversion circuit 533. It is connected between the vertical signal line 531-1 and the ground, and formed of a biasing MOS transistor having a gate to which a predetermined bias voltage VBI is applied.

The offset circuit 532 is provided to supply an offset to any one of the signals of the photodiodes PDA, PDB in the unit pixel 511. It is connected between the vertical signal line 531-1 and the ground, and comprises an offset MOS transistor having a gate to which a predetermined offset voltage VOF is applied.

The circuit construction as shown in FIG. 3 is used for the I-V conversion circuit 533, the CDS circuit 534, the comparator circuit 535 and the data latch circuit 536. That is, the I-V conversion circuit 533 comprises an inverter and a feedback resistor. The CDS circuit 535 basically comprises capacitors and switch transistors. A chopper type comparator is used as the comparator circuit 535, and D-FF is used as the data latch circuit 536.

The horizontal scanning portion 54 includes a horizontal scanning circuit 541 comprising, for example, a shift register, and a column selecting transistor 543 connected between the output terminal of the CDS circuit 534 and the horizontal signal line 542. A column selection signal HSL is successively output from the horizontal scanning circuit 541, and applied to the gate of the corresponding column selecting transistor 543 to switch the column selection transistor 543 to ON-state, thereby outputting the signal of each pixel 511 passing through the CDS circuit 534 to the horizontal signal line 542.

In the photodetector according to the third embodiment thus constructed, the shutter scanning circuit 522 is provided separately from the vertical scanning circuit 521 in the vertical scanning portion 52, and the reading MOS transistor of a line different from the line selected by the vertical scanning circuit 521 is switched to ON-state, whereby the accumulation time within the period corresponding to one frame can be controlled.

As in the case of the photodetectors of the second embodiment and the modification thereof, the photodetector according to this embodiment can be also used as the semiconductor sensor array having both the functions of the distance measuring sensor and the texture mapping image pickup sensor in the distance measuring equipment for measuring the shape of a three-dimensional object by using the light sectioning method.

In this case, the photodetector is designed so that the sensor sensitivity of the photodiodes PDA, PDB at the distance measuring time is set as the standard sensitivity, and when the photodetector is used to function as the distance measuring sensor, sufficient sensitivity can be obtained in the distance measuring operation by stopping the operation of the shutter scanning circuit 522. On the other hand, in the image pickup operation, the shutter scanning circuit 522 is actuated and the accumulation time in each pixel 511 is set to a proper value by the output timing of the shutter signal, whereby the optimum image signal can be obtained even in the image pickup operation having a long accumulation time.

As in the case of the modification of the second embodiment, the photodetector according to the third embodiment may be designed so that the signal of the pixel 511 is branched at the output stage of the I-V conversion circuit 533 and output through the column selecting transistor 543 to the horizontal signal line 542.

As described above, according to the present invention, in the photodetector and the distance measuring equipment using the same, the charges accumulated in the two photoelectric conversion elements provided every unit pixel are successively read out as signal current. In addition, the signal processing portion is provided every column, the signal processing between the respective signal voltages of the two photoelectric conversion elements is carried out in the signal processing portion. Therefore, even when there is a difference in characteristic between the two photoelectric conversion elements, the signal processing can be carried out with high precision and thus the detection sensitivity can be enhanced.

Further, the charges accumulated in the two photoelectric conversion elements are detected, and thus photocurrent is prevented from flowing stationarily. Therefore, the current consumption of the overall chip can be reduced, and also each unit pixel is simply constructed by two photoelectric conversion elements and five transistors, so that the numerical aperture of the pixel can be increased and thus the sensitivity can be further enhanced.

What is claimed is:

1. A photodetector including:
a pixel portion having unit pixels arranged in a matrix form, each unit pixel having two photoelectric conversion elements;
a first scanning portion for selecting the respective unit pixels of said pixel portion on a line basis; and
a signal processing portion for processing, every column, the signals that are output from said respective unit pixels to signal lines arranged every column of said pixel portion.

2. The photodetector as claimed in claim 1, wherein each of said unit pixels outputs charges photoelectrically-converted in said two photoelectric conversion elements as signal current to a signal line.

3. The photodetector as claimed in claim 1, wherein each of said unit pixels has two read-out transistors each of which is connected between each output terminal of said two photoelectric conversion elements and an accumulation portion for accumulating signal charges, a reset transistor for resetting said accumulation portion, an amplifying transistor for converting the signal charges accumulated in said accumulation portion to signal current, and a selecting transistor for selectively outputting the signal current from said amplifying transistor to said signal line.

4. The photodetector as claimed in claim 2, wherein said signal processing portion has an I-V conversion circuit for converting the signal current flowing through said signal line to a signal voltage every column.

5. The photodetector as claimed in claim 4, wherein said I-V conversion circuit comprises an inverter and a feedback resistor connected to the input and output terminals of said inverter.

6. The photodetector as claimed in claim 4, wherein said signal processing portion has a noise removing circuit for carrying out noise removing processing every column for the signal voltage converted in said I-V conversion circuit.

7. The photodetector as claimed in claim 6, wherein said noise removing circuit comprises a correlated double sampling circuit for taking the difference from a reference signal.

8. The photodetector as claimed in claim 4, wherein said signal processing portion has a comparison circuit for comparing the magnitude of the signal potential between the two signals based on said two photoelectric conversion elements which are successively output from said I-V conversion circuit.

9. The photodetector as claimed in claim 8, wherein said comparison circuit comprises an inverter, and a chopper type comparator having a transistor connected between the input and output terminals of said inverter.

10. The photodetector as claimed in claim 1, further including a second scanning portion for successively outputting the signals of said respective pixels processed every column by said signal processing portion for the pixels of a line selected by said first scanning portion.

11. The photodetector as claimed in claim 10, wherein said second scanning portion has a column selecting switch for successively selecting and outputting signals that are branched every column from some midpoint of said signal processing portion.

12. The photodetector as claimed in claim 10, wherein said first scanning portion has a shutter scanning circuit for controlling the accumulation time of charges in said unit pixels on a line basis.

13. Distance measuring equipment including:
slit light scanning means for scanning slit light along the surface of an object under measurement;
a semiconductor sensor array having unit pixels arranged in a matrix form, each of said unit pixels having two photoelectrical conversion elements which photodetect reflection slit light reflected from the object under measurement and are arranged so as to be adjacent to each other in the moving direction of the reflection slit light;
a first scanning portion for selecting each unit pixel of said semiconductor sensor array on a line basis;
a signal processing portion which is provided every column of said semiconductor sensor array and detects the time point of the passage of the reflection slit light over a unit pixel on the photodetection face on the basis of the two signals of said two photoelectrical conversion elements output from said unit pixel; and
a processing unit for determining the position on the surface of the object under measurement on the basis of the detection result of said signal processing portion.

14. The distance measuring equipment as claimed in claim 13, wherein said unit pixel outputs the charges photoelectrically-converted in said two photoelectric conversion elements as signal current.

15. The distance measuring equipment as claimed in claim 13, wherein each of said unit pixels has two read-out transistors each of which is connected between each output terminal of said two photoelectric conversion elements and an accumulation portion for accumulating signal charges, a reset transistor for resetting said accumulation portion, an amplifying transistor for converting the signal charges accumulated in said accumulation portion to signal current, and a selecting transistor for selectively outputting the signal current from said amplifying transistor to said signal line.

16. The distance measuring equipment as claimed in claim 13, wherein said signal processing portion has an I-V conversion circuit for converting the signal current output from said unit pixel to a signal voltage every column.

17. The distance measuring equipment as claimed in claim 13, wherein said signal processing portion has a comparison circuit for comparing the magnitude of the signal potential between the two signals based on said two photoelectric conversion elements which are successively output from said I-V conversion circuit.

18. The distance measuring equipment as claimed in claim 13, further including a second scanning portion for successively outputting the signals of said respective pixels processed every column by said signal processing portion for the pixels of a line selected by said first scanning portion.

19. The distance measuring equipment as claimed in claim 18, wherein said second scanning portion has a column selecting switch for successively selecting and outputting signals that are branched every column from some midpoint of said signal processing portion.

20. The distance measuring equipment as claimed in claim 18, wherein said first scanning portion has a shutter scanning circuit for controlling the accumulation time of charges in said unit pixels on a line basis.
